(19) United States
(12) Patent Application Publication
(10) Pub. No.: US 2026/0210184 A1
(43) Pub. Date: Jul. 23, 2026

(54) Ladder safety fastener

(71) Applicant: Likun Pang, Ningbo (CN)

(72) Inventor: Likun Pang, Ningbo (CN)

(21) Appl. No.: 19/031,179

(22) Filed: Jan. 17, 2025

(51) Int. Cl. E06C 7/48; B25B 5/08; B25B 5/16

(52) U.S. Cl. CPC E06C 7/488; B25B 5/085; B25B 5/163; B25B 5/166

(57) ABSTRACT

The present application relates to the technical field of ladder safety fixing, and discloses a ladder safety fixing clamp, including a shell, a clamping part, and a U-shaped limiter; a handle is formed at the bottom of the shell, a fixed clamp of the clamping part is fixed to the front side of the shell, and a movable clamp of the clamping part is correspondingly arranged on the front side of the fixed clamp. A U-shaped limiter is placed on the rear side of the shell to limit the ladder and also includes: a clamping control structure, under the action of the clamping control structure, the movable clamp moves linearly along the front and rear directions; a long rack adjustment structure, which is arranged in the shell, and the U-shaped limiter is adjusted in position in the front and rear directions through the long rack adjustment structure.

### FILD OF THE APPLICATION

The application relates to the technical field of ladder safety fixing, specifically refers to a ladder safety fastener.

### BACKGROUND

When performing high-altitude outdoor work, such as repairing roofs or shoveling snow, a ladder is often used as a temporary means to access elevated areas. During this time, the ladder relies solely on friction against the wall for support. If the ladder slips or shifts, it can lead to a dangerous fall for the person standing on it, posing serious safety risks.

Currently, when setting up a ladder for high-altitude work outdoors, an additional person is typically required to assist by holding and stabilizing the ladder. While this practice helps prevent the ladder from falling and potentially injuring the climber, it necessitates more manpower and coordination, which can be cumbersome and time-consuming.

### SUMMARY

The technical problem to be solved by the application is to overcome the above technical difficulties and provide a ladder safety fixing clamp, which can fix the ladder on the wall, and adjust the position of the limit rod through the cooperation of the long rack, and lock and automatically reset in one direction under the action of the spring, and the fixing operation method is simpler and more convenient. In addition, the clamp head of the F-type woodworking clamp can clamp eaves of different thicknesses.

To solve the above technical problems, the technical solution provided by the application is:
A ladder safety fastener, comprising a housing, a clamping portion and a U-shaped limiting member; a handle is formed at the bottom of the housing; a fixed clamp of the clamping portion is fixed to the front side of the housing; a movable clamp of the clamping portion is correspondingly arranged at the front side of the fixed clamp; and the U-shaped limiting member is arranged at the rear side of the housing to limit the ladder;
wherein a clamping control structure, under the action of which, the movable clamp moves linearly in the front-rear direction;
wherein a long rack adjustment structure, arranged in the housing, and the U-shaped limiter is adjusted in position in the front-rear direction through the long rack adjustment structure.
1. The long rack adjustment structure includes a slider, a short rack, a long rack and a locking cam; the slider is a U-shaped plate structure with an opening arranged toward the rear, and is slidably arranged in the shell, and the U-shaped limiter cross bar section is movably sleeved on the left and right side plates of the slider at the same time, the front end of the long rack is fixed on the shell, and the rear end is movably sleeved on the front side wall of the slider, a sleeve is formed on the top of the slider, the short rack is movably sleeved in the sleeve, and the bottom is meshed with the long rack, and the top is connected to the top wall of the slider through a, and a connecting rod is formed on the top, the connecting rod passes through the top wall of the slider, and is hinged to the locking cam, and after the locking cam is flipped forward, the short rack is separated from the long rack, and the slider can slide freely forward and backward.

The teeth of the long rack and the short rack are both one-way ratchet structures, and after they are meshed with each other, the slider cannot move backward along the long rack. At the same time, the front side wall of the slider is connected to the shell through two connections, and the two connections are sleeved on the long rack. After the locking cam flips forward, the short rack is separated from the long rack, and the slider moves backward under the action of the two connections.

It also includes a pair of plates, which are mirror-imaged on the left and right sides of the inner side of the slider, and the front end is fixed on the slider, and springs three are respectively arranged between the two plates and the inner wall of the slider, and the crossbar section of the U-shaped limiter is movably sleeved in the two C-shaped locking plates and the two springs three, and frictionally cooperates with the two C-shaped locking plates, and the U-shaped limiter is position-adjusted in the left and right directions through the two C-shaped locking plates.

The clamping part also includes an I-shaped rod and a pressure block. The I-shaped rod is arranged in the front-to-back direction and is slidably arranged in the shell. The movable clamp is fixed at the front end of the I-shaped rod. The two pressure blocks are respectively fixed at the bottom of the movable clamp and the fixed clamp. The clamping surface of the pressure block is inclined, and the clamping surfaces of the two pressure blocks cooperate.

The clamping control structure includes a wrench, an extrusion block, and a restoration paddle; the wrench, the pressing bloc, k and the restoration paddle are respectively movably sleeved on the I-shaped rod, and the wrench is arranged on the front side of the handle and hinged on the shell, the restoration paddle is frictionally matched with the I-shaped rod, so that the I-shaped rod cannot move forward, and after the restoration paddle is toggled, the I-shaped rod can move freely forward and backward, and after the wrench is pressed, the extrusion block is squeezed backward and frictionally matched with the I-shaped rod, and drives the I-shaped rod to move backward.

The advantages of the application compared to the prior art are as follows:
1. The clamping mechanism of the application is designed as an F-style woodworking clamp. This allows it to accommodate larger thicknesses and be used for eaves of varying thicknesses, resulting in a better clamping effect, enhanced applicability, and increased safety.
2. The limit rod of the application can adjust and secure its position using the long rack adjustment structure. It locks in one direction and can be reset in the reverse direction with the help of a spring, making it simple to operate and more convenient to use.
3. The application features a clamping control mechanism that utilizes an I-shaped rod in conjunction with an extrusion block. This automatically allows the clamping part to grip and secure the eaves, making it user-friendly and efficient.

### BRIEF DESCRIPTION OF THE DRAWINGS

FIG. 1 is a perspective view of a ladder safety fastener;

FIG. 2 is a perspective view of the clamping control structure of the ladder safety fastener thereof;

FIG. 3 is a partial structural cross-section of the ladder safety fastener thereof;

FIG. 4 is a perspective view of the structure of the long rack adjustment structure of the ladder safety fastener thereof;

FIG. 5 is a cross-section view of the ladder safety fastener.

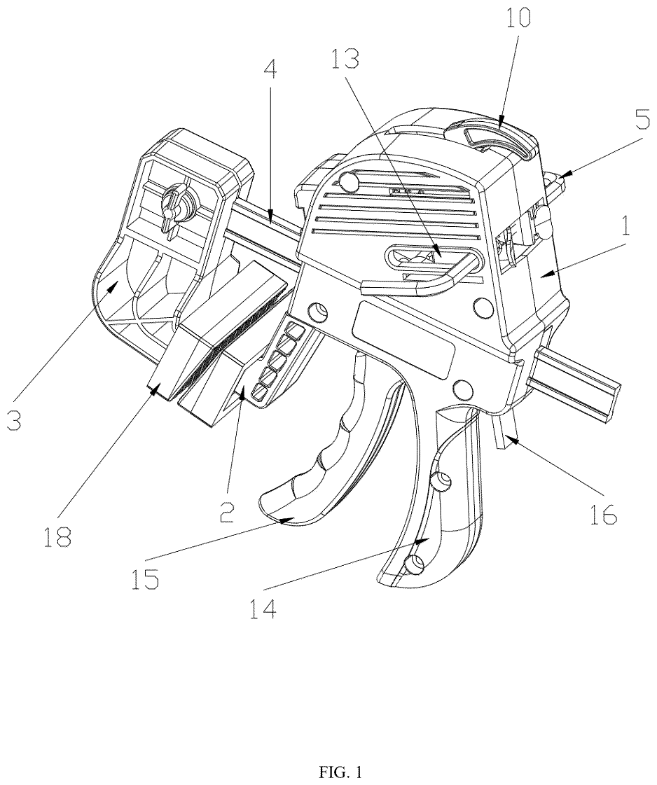

As show in FIGS. 1-5:
1. shell;
2. fixed chuck;
3. movable chuck;
4. I-shaped rod;
5. U-shaped limiter;
6. slider;
7. short rack;
8. long rack;
9. positioning plate;
10. locking cam;
11. sleeve;
12. C-shaped locking plate;
13. slide groove;
14. handle;
15. wrench;
16. restoration paddle;
17. extrusion block;
18. pressure block;
19. connecting rod;
20. first spring;
21. second spring;
22. third Spring;
23. forth Spring;
24. fifth Spring;
25. positioning pin

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

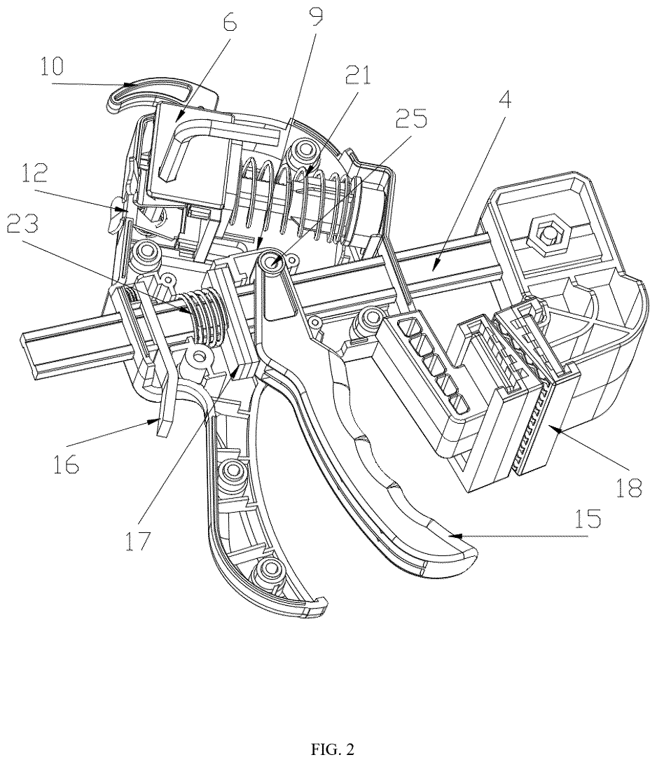

A ladder safety fastener, as shown in FIG. 1, comprising a shell 1, a clamping part and a U-shaped limiter 5, and a clamping control structure and a long rack adjustment structure are arranged in the shell 1 to control and adjust the clamping part and the U-shaped limiter 5. A handle 14 is formed at the bottom of the shell 1 for holding. The U-shaped limiter 5 is arranged at the rear side of the shell 1, and slide grooves 13 are reserved on both sides of the shell 1 (the angle between the slide groove 13 and the horizontal direction is about 15 degree). The two sides of the U-shaped limiter 5 are respectively slidably arranged in the slide grooves 13 on both sides. The clamping part is arranged on the front side of the shell 1, and the clamping part is an F-shaped woodworking clamping part. As shown in FIG. 2, the clamping part includes a fixed chuck 2, a movable chuck 3, The I-shaped rod 4 and the pressure block 18, the I-shaped rod 4 is arranged along the front-to-back direction and is slidably arranged in the shell 1, the movable clamp 3 is fixed at the front end of the I-shaped rod 4, the fixed clamp 2 is fixed at the front side of the shell 1, and the movable clamp 3 and the fixed clamp 2 are arranged correspondingly, and are respectively arranged vertically with the I-shaped rod 4 (the movable clamp 3 moves linearly along the front-to-back direction with the I-shaped rod 4), the two pressure blocks 18 are respectively fixed at the bottom of the movable clamp 3 and the fixed clamp 2, and the clamping surfaces are all inclined (the inclination angle is about 5 degree) and cooperate with each other (the clamping surfaces of the two pressure blocks 18 are always arranged parallel to each other), and the clamping surfaces of the two pressure blocks 18 are provided with anti-slip textures

The clamping control structure is arranged in the shell 1, and as shown in FIG. 2, it includes a wrench 15, an extrusion block 17 and a restoration paddle 16; a U-shaped positioning plate 9 is fixed inside the shell 1, and the positioning plate 9 is arranged on the upper side of the I-shaped rod, a positioning pin 25 is formed on the inner wall of the shell 1, and the positioning pin 25 is arranged on the inner side of the positioning plate 9, the wrench 15, the extrusion block 17 and the restoration paddle 16 are respectively movably sleeved on the I-shaped rod 4, and the wrench 15 is arranged on the front side of the handle 14, and the top passes through the shell 1 and is movably sleeved on the positioning pin 25, the extrusion block 17 is arranged on the rear side of the wrench 15, and after the rear side wall is connected to the shell 1 through the forth spring 23, the top of the front side wall abuts on the positioning plate 9, the bottom contacts with the protrusion formed on the wrench 15. After the wrench 15 is flipped backward and pressed, the bottom of the extrusion block 17 tilts backward and frictionally cooperates with the I-shaped rod 4, and moves backward together with the I-shaped rod 4. After the movement is completed, the extrusion block 17 slides forward along the I-shaped rod 4 under the action of forth spring 23. The restoration paddle 16 is set on the rear side of the shell 1, and the bottom is set through the shell 1. After the top of the restoration paddle 16 is connected to the rear side wall of the shell 1 through fifth spring 24, the top tilts forward and frictionally cooperates with the I-shaped rod 4 to prevent the I-shaped rod 4 from moving forward. After the restoration paddle 16 is toggled, the I-shaped rod 4 is movably sleeved in the restoration paddle 16 and can slide freely forward and backward. The above-mentioned F-type woodworking clamp (clamping part and clamping control structure) and its use method are both existing mature technologies.

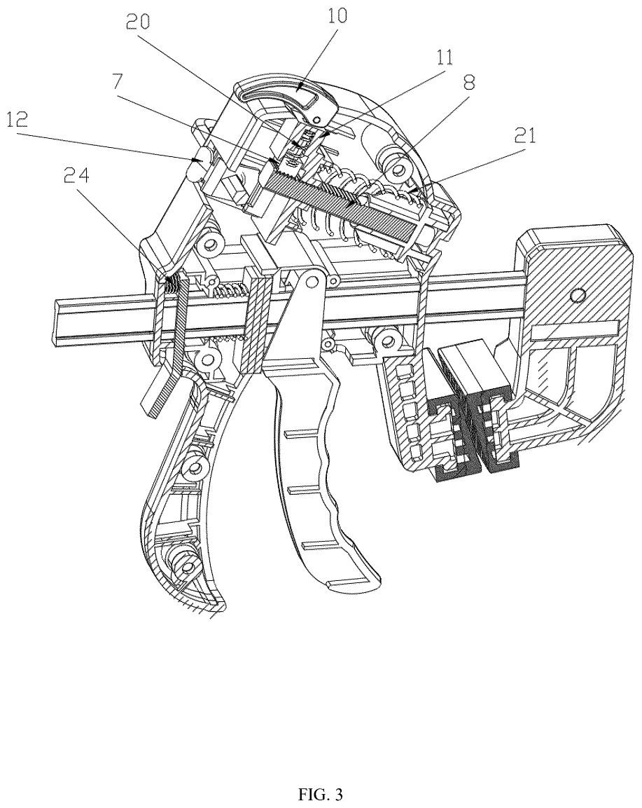

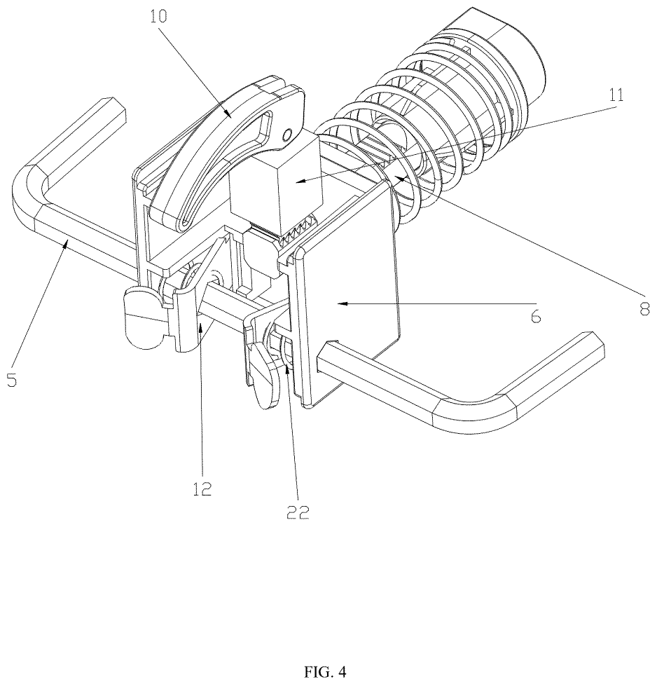

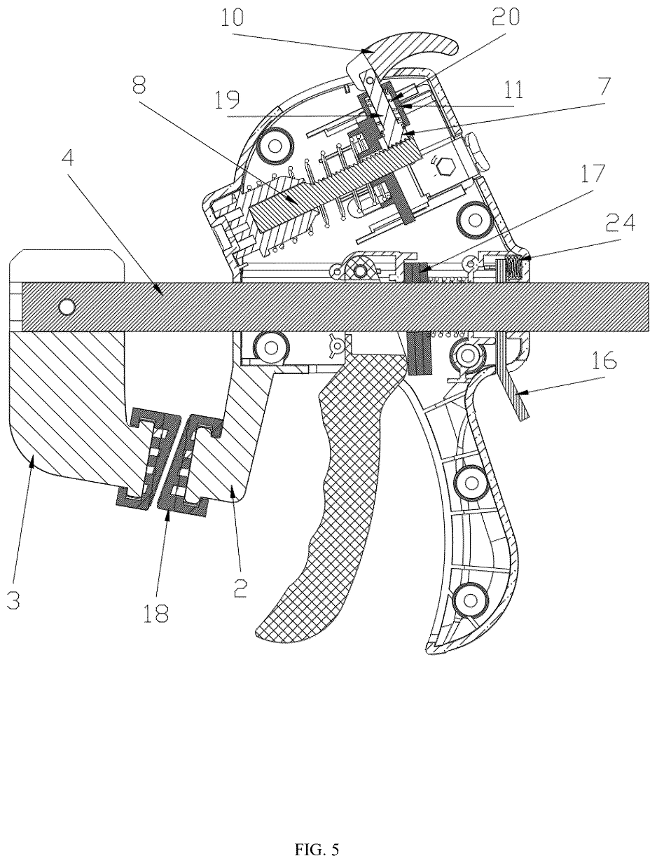

The U-shaped limiter 5 is a rod structure with a hexagonal cross-section, and the side rod is arranged parallel to the slide groove 13. The long rack adjustment structure is shown in FIGS. 3 and 4, including a slider 6, a short rack 7, a long rack 8, and a locking cam 10; slider 6 is a U-shaped plate structure with an opening arranged toward the rear and is slidably positioned in the shell 1, and a square sleeve 11 is fixed on the top of the slider. The crossbar section of the U-shaped limiter 5 is simultaneously movably sleeved on the left and right side plates of the slider 6, the front end of the long rack 8 is fixed on the shell 1, and the rear end is movably sleeved on the front side wall of the slider 6, and the front side wall of the slider 6 is connected to the shell 1 through a spring 21, and the spring 21 is sleeved on the long rack 8, and the short rack 7 is movably sleeved on the front side wall of the slider 6. The movable sleeve is connected in sleeve 11, the bottom is meshed with the long rack 8, and the top is connected to the top wall of the slider 6 through a first spring 20. At the same time, a connecting rod 19 is formed on the top, which passes through the top wall of the slider 6 and is hinged to the root of the locking cam 10 (as shown in FIG. 5, and the root of the locking cam 10 is a circular wheel structure with a gradually increasing radius, and it conflicts with the top of the slider 6), and after the locking cam 10 flips forward, the short rack 7 is disengaged from the long rack 8, and the slider 6 slides and returns to the rear side under the action of the spring 21. It is worth noting that the teeth of the long rack 8 and the short rack 7 are both one-way ratchet structures, and after meshing with each other, the slider 6 cannot move backward along the long rack 8.

Wherein a C-shaped locking piece 12 and a third spring 22; a pair of C-shaped locking pieces 12 are arranged in mirror images on the left and right sides of the inner side of the slider 6, and springs three 22 are respectively arranged between the inner walls of the slider 6, and the front end is fixed on the slider 6, and the cross bar section of the U-shaped limiter 5 is movably sleeved in the two C-shaped locking pieces 12 and the two springs three 22, and frictionally cooperates with the two C-shaped locking pieces 12.

In the specific implementation of this embodiment:
Put the ladder on the wall and climb up the ladder holding the present invention. When the chest reaches the eaves, take out the present invention and place the eaves between the two pressing blocks 18 of the F-shaped woodworking clamp. Press the wrench 15 to make the wrench 15 push the extrusion block 17 backward. The bottom of the extrusion block 17 tilts backward and frictionally cooperates with the I-shaped rod 4, while driving the I-shaped rod 4 to move backward together. After the movement is completed, the extrusion block 17 slides forward along the I-shaped rod 4 under the action of the forth spring 23, and the I-shaped rod 4 is restored. Plate 16 is locked and cannot move forward until the eaves are tightly clamped between the two pressure blocks 18, and the two C-shaped locking plates 12 on the rear side are pressed to disengage the U-shaped limiter 5 from the friction fit of the C-shaped locking plate 12, and the U-shaped limiter 5 is pulled left and right, and after the inner side of one side rod is in contact with the outer wall of the ladder vertical rod, the U-shaped limiter 5 is pushed forward to make the ladder vertical rod buckle on the inner side of the U-shaped limiter 5, and the ladder (including the ladder with a rectangular cross-section and a circular cross-section vertical rod) is firmly fixed on the eaves by the present invention.

After use, the ladder is withdrawn to the ground. When the chest reaches the eaves, the locking cam 10 is flipped up, and the short rack 7 moves upward to disengage from the long rack 8. The slider 6 moves backward along the slide groove under the action of the spring 21, releasing the U-shaped limiter 5 from fixing the ladder. Then, the handle 14 is held and the rear restoration paddle 16 is moved to release the F-shaped woodworking clamp from the locked state and remove it from the eaves. Finally, it is carefully and safely returned to the ground.

According to the specific situation, multiple new types can be used on a ladder to fix it at the same time, to strengthen the firmness of the ladder.

1. A ladder safety fastener, comprising a housing, a clamping portion and a U-shaped limiting member; a handle is formed at the bottom of the housing; a fixed clamp of the clamping portion is fixed to the front side of the housing; a movable clamp of the clamping portion is correspondingly arranged at the front side of the fixed clamp; and the U-shaped limiting member is arranged at the rear side of the housing to limit the ladder;
wherein a clamping control structure, under the action of which, the movable clamp moves linearly in the front-rear direction;
wherein a long rack adjustment structure, arranged in the housing, and the U-shaped limiter is adjusted in position in the front-rear direction through the long rack adjustment structure.

2. The ladder safety fastener of claim 1, wherein the long rack adjustment structure comprises a slider, a short rack, a long rack, and a locking cam; the slider is a U-shaped plate structure with an opening facing backward and is slidably arranged in the housing; the cross bar section of the U-shaped limiter is simultaneously movably sleeved on the left and right side plates of the slider; the front end of the long rack is fixed on the housing and the rear end is movably sleeved on the front side wall of the slider; the bottom of the short rack meshes with the long rack; a connecting rod is formed on the top and is connected to the top wall of the slider through a spring 1; the connecting rod passes through the top wall of the slider and is hinged to the locking cam; and after the locking cam flips forward, the short rack is separated from the long rack.

3. The ladder safety fastener of claim 2, wherein a sleeve fixed on the top wall of the slider, and the short rack is movably sleeved in the sleeve.

4. The ladder safety fastener of claim 2, wherein the teeth of the long rack and the short rack are both one-way ratchet structures, and after they are meshed with each other, the slider cannot move backward along the long rack.

5. The ladder safety fastener of claim 4, wherein the front side wall of the slider is connected to the housing via a second spring, and the second spring is sleeved on the long rack.

6. The ladder safety fastener of claim 2, wherein it also includes a pair of C-shaped locking plates which are arranged in a mirror image on the left and right sides of the inner side of the slider, and the front end is fixed on the slider; wherein the cross bar section of the U-shaped limiter is simultaneously movably sleeved in the two C-shaped locking plates and frictionally engaged with the two C-shaped locking plates; wherein the U-shaped limiter is adjusted in position in the left and right directions through the two C-shaped locking plates.

7. The ladder safety fastener of claim 6, wherein a spring is respectively provided between the two C-shaped locking pieces and the inner wall of the slider.

8. The ladder safety fastener of claim 1, wherein the clamping portion further comprises an I-shaped rod and a pressure block; the I-shaped rod is arranged in the front-to-back direction and is slidably arranged in the housing; the movable clamp is fixed at the front end of the I-shaped rod; the two pressure blocks are respectively fixed at the bottom of the movable clamp and the fixed clamp; the clamping surface of the pressure block is arranged to be inclined, and the clamping surfaces of the two pressure blocks cooperate with each other.

9. The ladder safety fastener of claim 8, wherein the clamping control structure comprises a wrench, an extrusion block, and a restoration paddle; the wrench, the pressing block and the restoration paddle are respectively movably sleeved on the I-shaped rod, and the wrench is arranged on the front side of the handle and is hinged to the housing; the restoration paddle is frictionally engaged with the I-shaped rod, and the I-shaped rod cannot move forward; when the wrench is pressed, the extrusion block is frictionally engaged with the I-shaped rod, and drives the I-shaped rod to move backward.
